(19) United States
(12) Patent Application Publication
(10) Pub. No.: US 2012/0062980 A1
(43) Pub. Date: Mar. 15, 2012

(54) COLOR ELECTRONIC PAPER DISPLAY DEVICE AND METHOD FOR MANUFACTURING THE SAME

(75) Inventors: Sang Jin KIM, Gyeonggi-do (KR); Young Soo OH, Gyeonggi-do (KR); Hwan Soo LEE, Gyeonggi-do (KR); Jung Min PARK, Gyeonggi-do (KR); Tae Hoon KIM, Gyeonggi-do (KR); Sang Moon LEE, Seoul (KR)

(73) Assignee: SAMSUNG ELECTRO-MECHANICS CO., LTD.

(21) Appl. No.: 13/052,580

(22) Filed: Mar. 21, 2011

(30) Foreign Application Priority Data
Sep. 9, 2010 (KR) 10-2010-0088450

(51) Int. Cl. G02F 1/167; B05D 5/12; B05D 5/06

(52) U.S. Cl. 359/296; 427/58

(57) ABSTRACT

Disclosed herein are a color electronic paper display device and a method for manufacturing the same. The color electronic paper display device according to the present invention includes: a barrier rib structure including a plurality of cavities partitioned so that rotating balls are separately inserted thereinto; an electrode structure including an upper electrode and a lower electrode each formed over and under the barrier rib structure and applying voltage to the rotating balls; and a black coating layer formed on the surfaces of the barrier ribs of the barrier rib structure.

### CROSS REFERENCE TO RELATED APPLICATION

This application claims the benefit of Korean Patent Application No. 10-2010-0088450, filed on Sep. 9, 2010, entitled “Color Electronic Paper Display Device And Method For Manufacturing The Same”, which is hereby incorporated by reference in its entirety into this application.

### BACKGROUND OF THE INVENTION

1. Technical Field

The present invention relates to a color electronic paper display device and a method for manufacturing the same, and more particularly, to a color electronic paper display device with improved color sharpness and contrast ratio by coating a surface of a barrier rib with black nano particles, and a method for manufacturing the same.

2. Description of the Related Art

Among the next generation display devices, a color electronic paper display device has availability and flexibility larger than those of other display devices and is able to be driven with low power. Therefore, the color electronic paper display device can replace paper printed media such as books and can be applied to various kinds of fields, such as screens, electronic wall papers, and the like.

As a typical color electronic paper display device, there is a color electronic paper display device using rotating balls formed of hemispheres having different colors. The twist ball-type color electronic paper display device includes a plurality of rotating balls, a barrier rib structure that partitions the rotating balls, an electrode structure that rotates the rotating balls, and transparent insulating oil that provides lubrication to the rotating balls. Herein, the hemispheres forming a single rotating ball have different colors and are further electrified with different charges. Alternatively, any one of the hemispheres may only be selectively electrified with positive (+) or negative (−) charges.

Therefore, the electrode structure applies voltage to the rotating balls to rotate the rotating balls in order that any one of the hemispheres selectively faces the outside, thereby making it possible to represent color to the outside.

At this time, when color is represented by any one of the hemispheres, color from the other hemisphere is prevented from being represented by the barrier rib structure. However, while the color is represented by any one of the hemispheres, color of the other hemisphere is also substantially represented to the outside. This phenomenon is generated as the color of the other hemisphere is represented when the light incident on a gap between the rotating balls and the barrier rib structure is leaked again to the outside from the gap.

In other words, when red, green, and blue hemispheres are used in order to represent colors in the color electronic paper display device which is a reflective display, light emitted from the colored hemisphere is reflected on a bright colored lower electrode made of copper or aluminum and a barrier rib formed on the lower electrode to be discharged to the outside, such that each color may not be clearly distinguished outside.

As described above, when the color is represented by any one of the hemispheres and the color of the other hemisphere is also represented, the color contrast ratio and sharpness of the color electronic paper display device are degraded.

### SUMMARY OF THE INVENTION

The present invention is devised to solve the disadvantages proposed in the color electronic paper display device according to the prior art. An object of the present invention is to provide a color electronic paper display device with improved color reproduction and contrast ratio as light emitted from hemispheres is absorbed by coating surfaces of barrier ribs into which a plurality of twist balls are injected and a lower electrode with black nano particles, and a method for manufacturing the same.

According to an exemplary embodiment of the present invention, there is provided a color electronic paper display device, including: a barrier rib structure including a plurality of cavities partitioned so that rotating balls are separately inserted thereinto; an electrode structure provided on the barrier rib structure and applying voltage to the rotating balls; and a black coating layer formed on the surfaces of the barrier ribs of the barrier rib structure and the lower electrode of the electrode structure.

At this time, the black coating layer may be formed of a nano ink made of black nano particles so as to have a lower brightness as compared to that of the barrier rib and the lower electrode.

The nano ink forming the black coating layer may use any one of a water-based nano ink, an oil-based nano ink, and UV-based nano ink.

The black coating layer may have a thickness of 2 to 10 μm, preferably, 2 to 3 μm.

The water-based nano ink may use an ink solvent for a fountain pen or printer produced by including 3 wt % of pigment including black nano particles, 1 wt % of dispersant, 5 wt % of penetration agent, 1 wt % of defoamer, 20 wt % of wetting agent, and 5 wt % of diluted solvent.

The UV-based nano ink may use an ink solvent produced by including 2 wt % of pigment including black nano particles, 1 wt % of dispersant, 30 wt % of diluent, 10 wt % of oligomer, 10 wt % of thermosetting initiator.

According to another exemplary embodiment of the present invention, there is provided a method for manufacturing a color electronic paper display device, including: forming a barrier rib structure having a plurality of cavities partitioned so that rotating balls are separately inserted thereinto; forming a black coating layer on the surface of barrier ribs of the barrier rib structure; separately disposing the rotating balls in each of the cavities; and forming an electrode structure on the barrier rib structure, the electrode structure applying voltage to the rotating balls.

At this time, the method for manufacturing a color electronic paper display device may further include preparing a base substrate for supporting the barrier rib structure.

At the forming the black coating layer on the surface of barrier ribs of the barrier rib structure, the black coating layer may be formed in a thin film type by a spray coating method or a doping coating method.

After the forming the black coating layer, the method for manufacturing a color electronic paper display device may further include performing a heat-treatment on the black coating layer formed on the barrier ribs, wherein the performing the heat-treatment on the black coating layer includes a primary heat-treatment performed at a temperature of 80° C. for 2 minutes and a secondary heat-treatment performed at a temperature of 110° C. for 3 minutes.

### BRIEF DESCRIPTION OF THE DRAWINGS

FIGS. 1 to 3 are cross-sectional views showing a manufacturing process of a color electronic paper display device according to the present invention; and

FIG. 4 is a flow chart showing a method for manufacturing a color electronic paper display device according to an exemplary embodiment of the present invention.

### DESCRIPTION OF THE PREFERRED EMBODIMENTS

The acting effects and technical configuration with respect to the objects of a color electronic paper display device and a method for manufacturing the same according to the present invention will be clearly understood by the following description in which exemplary embodiments of the present invention are described with reference to the accompanying drawings.

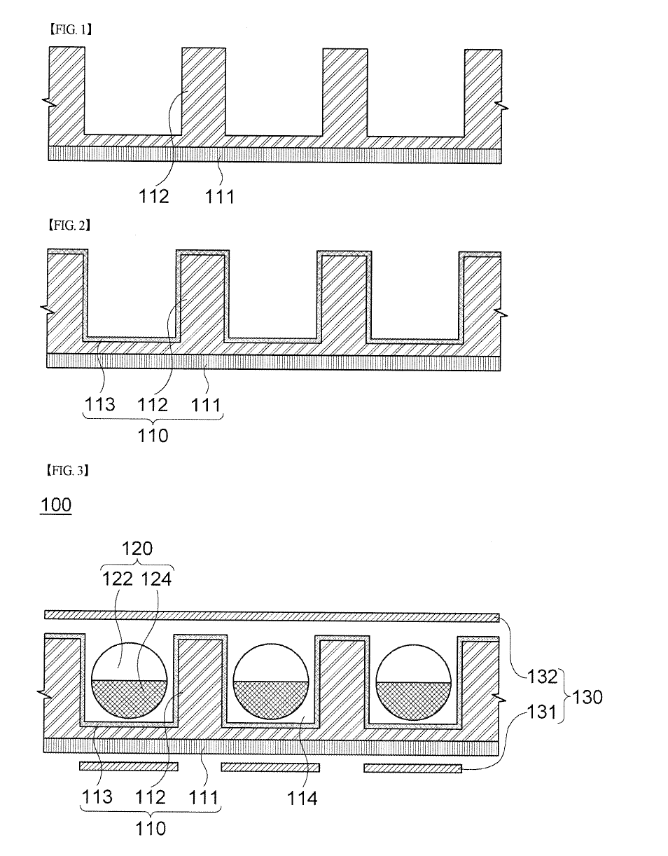

First, FIGS. 1 to 3 are cross-sectional views showing a manufacturing process of a color electronic paper display device according to the present invention.

As shown in the figures, a color electronic paper display device 100 according to an exemplary embodiment of the present invention includes a barrier rib structure 110, rotating balls 120, and an electrode structure 130.

In this configuration, the barrier rib structure 110 may include a base substrate 111, a plurality of barrier ribs 112, and a black coating layer 113 formed on the surfaces of the barrier ribs 112. The plurality of barrier ribs 112 may be arranged on the base substrate 111 in a row and cavities 114, which are space into which the plurality of rotating balls 120 are inserted, may be formed by each of the barrier ribs 112.

The black coating layer 113 may be formed on the each of the barrier ribs 112 of the barrier rib structure 110 in which the cavities 114 are formed. The black coating layer 113 may be selectively formed on the surfaces of the barrier ribs 112 and may also be made of a material having a higher light absorbency as compared to that of the barrier ribs 112. Therefore, the black coating layer 113 may be formed of a coating layer having a relatively lower brightness as compared to that of the material forming the barrier ribs 112.

More specifically, the black coating layer 113 may be formed by applying nano ink including nano particles so as to be configured in colors having lower brightness as compared to that of the barrier rib 112, that is, in gray or black capable of absorbing light.

At this time, the nano ink forming the black coating layer 113, which is any one of water-based nano ink, oil-based nano ink, and UV-based nano ink cured by light irradiation, is applied on the barrier rib 112 at a predetermined thickness, such that black coating layer 113 may be formed on the bottom surface of the cavity 114 formed by the barrier rib 112 as well as the top surface and wall surface of the barrier rib 112.

In addition, the black coating layer 113 may be formed on the surface of the barrier rib 112 at a thickness of about 2 to 10 μm, preferably, at a thickness of 2 to 3 μm. At this time, when the black coating layer 113 formed on the barrier rib 112 has a thickness of 2 μm or less, the color of the barrier rib 112 may be transmitted onto the coating layer, such that light absorbency is degraded. In addition, as the thickness of the black coating layer 113 formed on the barrier rib 112 becomes thicker, light absorbency may be improved. However, when the thickness of the black coating layer 113 becomes thicker than 10 μm, the outer circumferential surface of the rotating ball 120 inserted into the cavity 114 formed by the barrier rib 112 may be in contact in with the black coating layer 113, such that rotatory force of the rotating ball 120 may be degraded.

In addition, the water-based nano ink may use an ink solvent for a fountain pen or printer produced by including 3 wt % of pigment, 1 wt % of dispersant, 5 wt % of penetration agent, 1 wt % of defoamer, 20 wt % of wetting agent, and 5 wt % of diluted solvent. The UV-based nano ink may use an ink solvent produced by including 2 wt % of pigment including black nano particles, 1 wt % of dispersant, 30 wt % of diluent, 10 wt % of oligomer, and 10 wt % of thermosetting initiator.

In the barrier rib structure 110 configured as described above, light discharged through the color hemispheres of the rotating balls 120 inserted into the cavities 114 formed by the barrier ribs 112 is absorbed by the black coating layer 113 formed on the wall surfaces of the barrier ribs 112 to prevent the light reflected through the barrier ribs 112 from being discharged to the outside of the color electronic paper display device, thereby making it possible to improve unique color reproduction of the rotating balls.

The rotating balls 120 may have a sphere shape. The rotating balls 120 may each be formed of first and second hemispheres 122 and 124 that are electrified with different charges. In addition, the first and second hemispheres 122 and 124 may have different colors. As an example, when the color electronic paper display device 100 is a white/black display device, the first hemisphere 122 may be a white hemisphere and the second hemisphere 124 may be a black hemisphere. As another example, when the color electronic paper display device is a color display device, the first hemisphere 122 may be any one of a blue hemisphere, a yellow hemisphere, a red hemisphere and a green hemisphere, and the second hemisphere 124 may be a black hemisphere or a white hemisphere. The colors of the first and second hemispheres 122 and 124 of each of the rotating balls 120 may be changed and combined in various manners.

The electrode structure 130 may include a lower electrode 131 that is disposed under the barrier rib structure 110 and an upper electrode 132 that is disposed over the barrier rib structure 110, which rotate the rotating balls 120. The lower and upper electrodes 131 and 132 selectively apply voltage to the rotating balls 120, thereby making it possible to rotate the rotating balls 120 in order that the hemisphere of the first and second hemispheres 122 and 124, having the color to be represented, faces the outside of the display device, that is, faces the upper portion as shown in FIG. 3.

At this time, the light reflected through the first hemispheres 122 of the rotating balls 120 may be reflected through the lower electrode 131, such that the black coating layer 113 may also be formed on the surface of the lower electrode 131 in the same manner as the surface of the barrier rib 112.

In the color electronic paper display device 100 according to the exemplary embodiment of the present invention configured as described above, the rotating balls 120 are rotated in the cavities 114 formed by the plurality of barrier ribs 112 by the voltage applied to the upper electrode 132 and the lower electrode 131, and the second hemisphere 124 is surrounded by the barrier ribs 112 while the first hemisphere 122 represents its color to the outside, that is, to the upper portion of the display device, by the rotation of the rotating balls 120, as shown in FIG. 3. At this time, the light reflected from the second hemisphere 124 may be absorbed by the black coating layer 113 formed on the barrier rib 112. Therefore, while the color is represented by any one hemisphere of the rotating balls 120, the color of the other hemisphere is prevented from being light-reflected to the barrier rib 112 of the barrier rib structure 110, thereby making it possible to improve the entire color sharpness and contrast ratio of the display device.

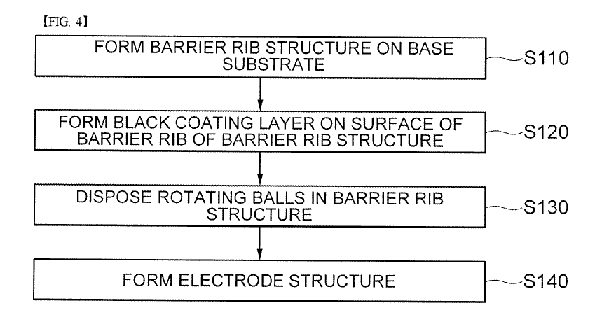

Meanwhile, a method for manufacturing a color electronic paper display device according to the exemplary embodiment of the present invention will be described in detail with reference to FIG. 4. Hereinafter, a description overlapping the color electronic paper display device may be omitted.

FIG. 4 is a flow chart showing a method for manufacturing a color electronic paper display device according to an exemplary embodiment of the present invention.

As shown in FIG. 4, the method for manufacturing a color electronic paper display device according to the exemplary embodiment of the present invention may first form a barrier rib structure 110 on a base substrate 111 (S110).

The forming the barrier rib structure 110 may include forming barrier ribs 112 on the base substrate 111 to form cavities 114 divided by the barrier ribs.

Next, a black coating layer 113 may be formed on the surfaces of the barrier ribs 112 configuring the barrier rib structure 110 (S120). The black coating layer 113 may be formed by any one process of a spray coating method, a doping coating method, an applying method, a physical vapor deposition, and a chemical vapor deposition.

In addition, after the forming the black coating layer 113, the method for manufacturing a color electronic paper display device according to the exemplary embodiment of the present invention may further include performing a heat-treatment on the black coating layer 113 formed on the barrier ribs 112, wherein the performing the heat-treatment on the black coating layer may include a primary heat-treatment performed at a temperature of 80° C. for 2 minutes and a secondary heat-treatment performed at a temperature of 110° C. for 3 minutes.

Next, rotating balls 120 may be disposed in the cavities 114 of the barrier rib structure 110 (S130). The rotating balls 120 may be disposed between the barrier ribs 112 configuring the cavities 114 of the barrier rib structure 110 so that the hemispheres are rotatable.

Thereafter, an electrode structure 130 including an upper electrode 132 and a lower electrode 131 over and under the barrier rib structure 110 (S140). At this time, the forming the electrode structure 130 further includes disposing the lower electrode 131 under the barrier rib structure 110 and disposing the upper electrode 132 over the barrier rib structure 110.

As described above, the color electronic paper display device and the method for manufacturing the same form a black coating layer capable of absorbing light emitted from the hemispheres of the rotating balls on the surfaces of the barrier ribs formed on the barrier rib structure and the lower electrode to light-reflect the color of the hemispheres through the lower electrode and the barrier ribs, such that the color of the hemispheres is prevented from being displayed to the outside, thereby making it possible to improve color reproduction and contrast ratio of the color electronic paper display device.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A color electronic paper display device, comprising:
a barrier rib structure including a plurality of cavities partitioned so that rotating balls are separately inserted thereinto;
an electrode structure including an upper electrode and a lower electrode each formed over and under the barrier rib structure and applying voltage to the rotating balls; and
a black coating layer formed on the surfaces of the barrier ribs of the barrier rib structure.

2. The color electronic paper display device according to claim 1, wherein the black coating layer is formed on the surface of the lower electrode of the electrode structure.

3. The color electronic paper display device according to claim 1 or 2, wherein the black coating layer is formed of a nano ink made of black nano particles so as to have a lower brightness as compared to that of the barrier rib and the lower electrode.

4. The color electronic paper display device according to claim 3, wherein the nano ink forming the black coating layer uses any one of a water-based nano ink, an oil-based nano ink, and UV-based nano ink.

5. The color electronic paper display device according to claim 1, wherein the black coating layer has a thickness of 2 to 10 μm.

6. The color electronic paper display device according to claim 4, wherein the water-based nano ink uses an ink solvent produced by including 3 wt % of pigment including black nano particles, 1 wt % of dispersant, 5 wt % of penetration agent, 1 wt % of defoamer, 20 wt % of wetting agent, and 5 wt % of diluted solvent.

7. The color electronic paper display device according to claim 4, wherein the UV-based nano ink uses an ink solvent produced by including 2 wt % of pigment including black nano particles, 1 wt % of dispersant, 30 wt % of diluent, 10 wt % of oligomer, and 10 wt % of thermosetting initiator.

8. A method for manufacturing a color electronic paper display device, comprising:
forming a barrier rib structure having a plurality of cavities partitioned so that rotating balls are separately inserted thereinto;
forming a black coating layer on the surface of barrier ribs of the barrier rib structure;
separately disposing the rotating balls in each of the cavities; and
forming an electrode structure on the barrier rib structure, the electrode structure applying voltage to the rotating balls.

9. The method for manufacturing a color electronic paper display device according to claim 8, further comprising preparing a base substrate for supporting the barrier rib structure.

10. The method for manufacturing a color electronic paper display device according to claim 8, wherein at the forming the black coating layer on the surface of barrier ribs of the barrier rib structure, the black coating layer is formed in a thin film type by a spray coating method or a doping coating method.

11. The method for manufacturing a color electronic paper display device according to claim 8, further comprising, after the forming the black coating layer, performing a heat-treatment on the black coating layer formed on the barrier ribs,
wherein the performing the heat-treatment on the black coating layer includes a primary heat-treatment performed at a temperature of 80° C. for 2 minutes and a secondary heat-treatment performed at a temperature of 110° C. for 3 minutes.
